(19) United States
(12) Patent Application Publication
(10) Pub. No.: US 2014/0209348 A1
(43) Pub. Date: Jul. 31, 2014

(54) MULTI-CORE CABLE

(71) Applicant: SUMITOMO ELECTRIC INDUSTRIES, LTD., Osaka (JP)

(72) Inventors: Tatsunori HAYASHISHITA, Osaka (JP); Yuuki ISOYA, Hachinohe (JP)

(73) Assignee: SUMITOMO ELECTRIC INDUSTRIES, LTD., OSAKA (JP)

(21) Appl. No.: 13/830,722

(22) Filed: Mar. 14, 2013

(30) Foreign Application Priority Data
Jan. 25, 2013 (JP) 2013-011620

(51) Int. Cl. H01B 11/20

(52) U.S. Cl. CPC H01B 11/20
USPC 174/106 R

(57) ABSTRACT

A multi-core cable includes a plurality of small diameter coaxial electronic wires arranged on the same circumference, a tape wrapping formed with an electrically conductive resin tape which is wound on the periphery of the plurality of small diameter coaxial electronic wires, and a shield layer covering the periphery of the plurality of small diameter coaxial electronic wires through the tape wrapping.

### BACKGROUND

1. Technical Field

The present disclosure relates to a multi-core cable having a plurality of small diameter coaxial electronic wires.

2. Related Art

As a high-speed interface cable having signal wires for a high-speed transmission and power supply wires, a cable is known in which a central interposition is provided in a sheath, and, in the periphery thereof, coaxial signal wires having an even number of four or more wires formed as pairs are arranged substantially with the same distance spaced from a central part of the central interposition in a section of the cable, that is, so as to be located in the same layer (for instance, see patent literature 1)

### LITERATURE OF RELATED ART

### Patent Literature

### [Patent Literature 1] JP-A-2010-33879

In recent years, a high-speed transmission progresses in a cable for a peripheral device which connects the peripheral device to a personal computer and an available frequency band is expanded to several GHz band. Further, as a transmitting system of a digital signal such as a video, a differential signal is mainly transmitted. When the differential signal is transmitted in such a high frequency band, a quantity of attenuation in the cable is requested to be suppressed.

However, after a plurality of coaxial electronic wires are collected and shielded together, the quantity of attenuation in the coaxial electronic wires may be sometimes increased to deteriorate an electric property.

### SUMMARY

Exemplary embodiments of the invention provide a multi-core cable which can obtain a good electric property.

A multi-core cable according to an exemplary embodiment comprises:

a plurality of small diameter coaxial electronic wires arranged on the same circumference;

a tape wrapping formed with an electrically conductive resin tape which is wound on the periphery of the plurality of small diameter coaxial electronic wires; and

a shield layer covering the periphery of the plurality of small diameter coaxial electronic wires through the tape wrapping.

At least one of the small diameter coaxial electronic wires and insulated electronic wires may be arranged in a center or a part in the vicinity of the center in a section vertical to a longitudinal direction of the cable and the small diameter coaxial electronic wires may be arranged on the same circumference in the periphery thereof.

The tape wrapping may be formed in the shape of a film having a thickness of 0.01 mm or more to 0.08 mm or smaller.

The electrically conductive resin tape of the tape wrapping may include an electrically conductive material mixed and dispersed in a tape formed with a polyethylene resin, a fluorine resin or a polyester resin.

According to the present invention, since a tape wrapping made of an electrically conductive resin tape is wound on a periphery of a plurality of small diameter coaxial electronic wires arranged on the same circumference, an increase in a quantity of attenuation in the small diameter coaxial electronic wires can be suppressed as much as possible by the tape wrapping and a shield layer in the periphery thereof and a good electric property can be obtained.

### BRIEF DESCRIPTION OF THE DRAWINGS

FIG. 1 is a sectional view showing one example of a multi-core cable according to an exemplary embodiment of the present invention.

### DETAILED DESCRIPTION

Now, an exemplary embodiment of a multi-core cable according to the present invention will be described below by referring to the drawing.

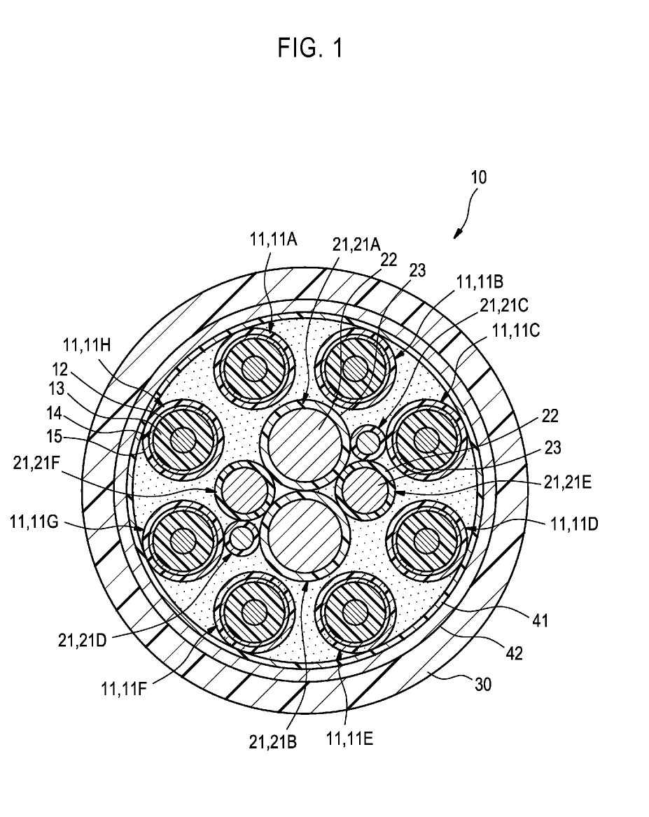

As shown in FIG. 1, the multi-core cable 10 according to the exemplary embodiment includes a plurality of small diameter coaxial electronic wires 11 for a high speed transmission and a plurality of insulated electronic wires 21 inside a sheath 30 as an outermost layer.

In the multi-core cable 10, in order to adapt the multi-core cable to a use for a differential transmission, the small diameter coaxial electronic wires 11 are accommodated with the two electronic wires respectively formed as a pair. In the multi-core cable 10 of this exemplary embodiment, as the small diameter coaxial electronic wires 11, four pairs of the small diameter coaxial electronic wires 11A and 11B, the small diameter coaxial electronic wires 11C and 11D, the small diameter coaxial electronic wires 11E and 11F and the small diameter coaxial electronic wires 11G and 11H are accommodated. Further, as the insulated electronic wires 21, the insulated electronic wires 21A and 21B, the insulated electronic wires 21C and 21D and the insulated electronic wires 21E and 21F are accommodated.

Each of the small diameter coaxial electronic wires 11 has a structure that a central conductor 12 is coated with an insulator 13, an outer conductor 14 is arranged in an outer periphery of the insulator 13 and an outer side thereof is covered and protected with a jacket 15. As the small diameter coaxial electronic wire 11 for the high-speed transmission, a small diameter coaxial electronic wire thinner than AWG (American Wire Gauge) No. 30 is used. In this exemplary embodiment, a small diameter coaxial electronic wire of AWG No. 34 is used.

As the central conductor 12, a strand having an outside diameter of 0.192 mm is used that is formed by twisting seven silver-plated annealed copper wires of a conductor diameter of 0.064 mm.

As the insulator 13, a fluorine resin of tetra fluoroethylene-hexa fluoropropylene copolymer (FEP) is used. The insulator 13 is formed by extrusion molding the fluorine resin. The insulator 13 has a thickness of 0.2 mm and an outside diameter of about 0.59 mm. Further, withstand voltage is about 1500 V.

The outer conductor 14 is formed by spirally winding a tin-plated annealed copper wire on the outer periphery of the insulator 13 and an outside diameter thereof is about 0.69 mm. The jacket 15 is formed by winding double a resin tape made of polyethylene terephthalate (PET). An outside diameter of the jacket 15 is about 0.72 mm.

Any of the insulated electronic wires 21 is formed by covering a conductor 22 with a jacket 23. The conductor 22 is formed with a strand made of a tin-plated annealed copper wire. Further, as a material of the jacket 23, a fluorine resin such as perfluoroalkoxy resin (PFA) is preferably used which is excellent in its heat resistance, chemical resistance, non-viscosity, self-lubricating property or the like.

A structural example of the insulated electronic wire 21 is shown. In the insulated electronic wires 21A and 21B, the conductor 22 with an outside diameter of 0.64 mm formed by twisting 19 element wires with a conductor diameter of 0.127 mm is covered with the jacket 23 to have an outside diameter of 0.76 mm. In the insulated electronic wires 21C and 21D, the conductor 22 with an outside diameter of 0.192 mm formed by twisting 7 element wires with a conductor diameter of 0.064 mm is covered with the jacket 23 to have an outside diameter of 0.31 mm. In the insulated electronic wires 21E and 21F, the conductor 22 with an outside diameter of 0.381 mm formed by twisting 7 element wires with a conductor diameter of 0.127 mm is covered with the jacket 23 to have an outside diameter of 0.51 mm.

In the multi-core cable 10 having the small diameter coaxial electronic wires 11 for the high-speed transmission and the insulated electronic wires 21, the insulated electronic wires 21 are arranged in the center and a space in the vicinity of the center in a section vertical to a longitudinal direction of the cable (as shown in FIG. 1). Then, in the periphery of the insulated electronic wires 21, the small diameter coaxial electronic wires 11 for the high-speed transmission are arranged on the same circumference. In gaps between the small diameter coaxial electronic wires 11 and the insulated electronic wires 21, interposing materials such as aramide fibers or staple yarns are provided.

On the periphery of the plurality of insulated electronic wires 21 and the small diameter coaxial electronic wires 11 arranged in such a way, a tape wrapping 41 is wound. Thus, the small diameter coaxial electronic wires 11 and the insulated electronic wires 21 are bundled without putting their arrangement into disorder.

Further, the periphery of the plurality of small diameter coaxial electronic wires 11 and the insulated electronic wires 21 is covered with a shield layer 42 through the tape wrapping 41. Then, an outer peripheral side of the shield layer 42 is further covered with a sheath 30.

As the tape wrapping 41, an electrically conductive resin tape is used. A resin tape forming the electrically conductive resin tape is formed with a fluorine resin such as polytetra fluoroethylene (PTFE) resin, a polyester resin such as polyethylene terephthalate (PET) or a polyethylene resin (PE) excellent in heat resistance, abrasion resistance or the like. In the electrically conductive resin tape used as the tape wrapping 41, in order to obtain an electric conductivity, an electrically conductive material such as carbon is mixed so as to be dispersed in a resin forming the resin tape. A surface resistance value of the electrically conductive resin tape is preferably set to 1.0×10⁶Ω or lower. The surface resistance value of 1.0×10⁴ or lower is more preferable. For achieving the object of the present invention, when the surface resistance value of the electrically conductive tape comes closer to zero, a result is the more preferable. The tape wrapping 41 is formed in the shape of a film having a thickness of 0.01 mm or more and 0.08 mm or smaller. A winding direction of the tape wrapping 41 may be set to the same direction as or an opposite direction to a stranding direction when the insulated electronic wires 21 and the small diameter coaxial electronic wires 11 are collected. An overlapping width of the electrically conductive resin tape used for the tape wrapping 41 is desirably set to ½ to ¼ times as wide as the width of the tape. A winding angle of the tape wrapping 41 is desirably set to 15 to 40° relative to the longitudinal direction of the cable. When the electrically conductive resin tape is wound, a tension of 1 to 5N is desirably applied to the tape.

The shield layer 42 is formed by spirally winding a tin-plated copper wire with an outside diameter of several ten μm or a copper alloy wire. The sheath 30 is formed with a polyvinyl chloride (PVC) or polyolefine resin or the like and an outside diameter of the sheath 30 is set to 4.0 mm or larger to 4.5 mm or smaller. In the multi-core cable 10 of the present exemplary embodiment including the eight small diameter coaxial electronic wires 11 of the AWG No. 34, a thickness of the sheath 30 is set to about 0.55 mm and an outside diameter is set to 4.3 mm.

In the multi-core cable 10 formed as described, since the tape wrapping 41 formed with the electrically conductive resin tape is wound on the periphery of the plurality of small diameter coaxial electronic wires 11 for the high-speed transmission, an increase in a quantity of attenuation in the small diameter coaxial electronic wires 11 can be suppressed as much as possible by the tape wrapping 41 and the shield layer 42 in the periphery thereof. Accordingly, the multi-core cable 10 can be preferably used as a cable for transmitting a differential signal in a high frequency band.

Since the tape wrapping 41 is formed in the shape of a film having the thickness of 0.01 mm or more to 0.08 mm or smaller. Further, since the electrically conductive material is mixed so as to be dispersed in the tape formed with the fluorine resin, the polyester resin or the polyethylene resin, a suppressing effect of the increase of the quantity of attenuation can be improved.

In the multi-core cable of the present exemplary embodiment on which the tape wrapping formed with the electrically conductive resin tape is wound and a multi-core cable of a comparative example on which a tape wrapping of other structure is wound, quantities of attenuation (dB/m) when a signal of a high frequency band (5 GHz) is transmitted in an environment of 20° C. are measured by a network analyzer and compared with each other.

As the tape wrapping of other structure in the multi-core cable of the comparative example, a thin paper tape, a metal tape to which an aluminum foil is stuck and a resin tape formed with a polytetra fluoroethylene (PTFE) resin are used.

As a result, in the multi-core cable according to the present exemplary embodiment using the electrically conductive resin tape (an electrically conductive PET tape) as the tape wrapping, a maximum attenuation is 4.7 dB/m, a minimum attenuation is 4.6 dB/m and an average attenuation is 4.7 dB/m.

Further, in the multi-core cable using the electrically conductive PE tape as the tape wrapping, a maximum attenuation is 4.6 dB/m, a minimum attenuation is 4.4 dB/m and an average attenuation is 4.5 dB/m.

As compared therewith, in the multi-core cable using the thin paper tape as the tape wrapping, a maximum attenuation is 5.2 dB/m, a minimum attenuation is 5.0 dB/m and an average attenuation is 5.1 dB/m. Further, in the multi-core cable using the metal tape as the tape wrapping, a maximum attenuation is 5.3 dB/m, a minimum attenuation is 5.0 dB/m and an average attenuation is 5.1 dB/m. In the multi-core cable using the resin tape as the tape wrapping, a maximum attenuation is 5.2 dB/m, a minimum attenuation is 4.8 dB/m and an average attenuation is 5.0 dB/m.

As described above, in the multi-core cable according to the present exemplary embodiment which uses the electrically conductive resin tape as the tape wrapping, the quantity of attenuation can be suppressed as much as possible. Especially, when the electrically conductive PE tape is used as the pressing roll, it is recognized that an effect for suppressing the increase of the quantity of attenuation is high.

The number of the small diameter coaxial electronic wires 11 and the insulated electronic wires 21 in the multi-core cable 10 of the above-described exemplary embodiment is not limited to that of the exemplary embodiment. In the above-described exemplary embodiment, the plurality of insulated electronic wires 21 are arranged in the central side and the small diameter coaxial electronic wires 11 for the high speed transmission are arranged in the periphery thereof. However, in place of the insulated electronic wires arranged in the central side, the small diameter coaxial electronic wires which are not used for the high-speed transmission may be arranged. Otherwise, both the insulated electronic wires and the small diameter coaxial electronic wires which are not used for the high-speed transmission may be respectively arranged inside of the small diameter coaxial electronic wires 11 for the high speed transmission. Further, a structure may be formed in which only the plurality of small diameter coaxial electronic wires 11 for the high speed transmission are accommodated.

What is claimed is:

1. A multi-core cable comprising:
a plurality of small diameter coaxial electronic wires arranged on the same circumference;
a tape wrapping formed with an electrically conductive resin tape which is wound on the periphery of the plurality of small diameter coaxial electronic wires; and
a shield layer covering the periphery of the plurality of small diameter coaxial electronic wires through the tape wrapping.

2. The multi-core cable according to claim 1, wherein at least one of the small diameter coaxial electronic wires and insulated electronic wires are arranged in a center or a part in the vicinity of the center in a section vertical to a longitudinal direction of the cable and the small diameter coaxial electronic wires are arranged on the same circumference in the periphery thereof.

3. The multi-core cable according to claim 1, wherein the tape wrapping is formed in the shape of a film having a thickness of 0.01 mm or more to 0.08 mm or smaller.

4. The multi-core cable according to claim 1, wherein the electrically conductive resin tape of the tape wrapping includes an electrically conductive material mixed and dispersed in a tape formed with a polyethylene resin.

5. The multi-core cable according to claim 1, wherein the electrically conductive resin tape of the tape wrapping includes an electrically conductive material mixed and dispersed in a tape formed with a fluorine resin or a polyester resin.

6. The multi-core cable according to claim 3, wherein a surface resistance value of the tape wrapping is 1.0×10⁶Ω or lower.
